(19) United States
(12) Patent Application Publication
(10) Pub. No.: US 2012/0306112 A1
(43) Pub. Date: Dec. 6, 2012

(54) MOLDING MACHINE AND INJECTION MOLDING CONTROLLING METHOD

(75) Inventors: Harumichi Tokuyama, Odawara-shi (JP); Haruyuki Matsubayashi, Numazu-Shi (JP); Takeshi Iida, Numazu-Shi (JP)

(73) Assignee: TOSHIBA KIKAI KABUSHIKI KAISHA, Chiyoda (JP)

(21) Appl. No.: 13/483,906

(22) Filed: May 30, 2012

(30) Foreign Application Priority Data
May 31, 2011 (JP) 2011-122247

(51) Int. Cl. B29C 45/76

(52) U.S. Cl. 264/40.5; 425/149

(57) ABSTRACT

A molding machine according to an embodiment includes a stationary platen equipped with a stationary die, a movable platen equipped with a movable die, a locking drive mechanism to move the movable platen forward or backward and to lock the movable die against the stationary die, a detecting portion to detect information about a locking state, an injection device, and a control unit to monitor the information obtained by the detecting portion in an injecting process and to control an injection pressure of the injection device based on a value obtained from the information.

### CROSS-REFERENCE TO RELATED APPLICATIONS

This application is based upon and claims the benefit of priority from prior Japanese Patent Application No. 2011-122247, filed May 31, 2011, the entire contents of which are incorporated herein by reference.

### BACKGROUND OF THE INVENTION

1. Field of the Invention

The present invention relates to a molding machine comprising an injection device and an injection molding controlling method for the molding machine.

2. Description of the Related Art

Various molding machines that detect a malfunction in the molding process have been proposed.

Jpn. Pat. Appln. KOKAI Publication No. 2008-001028 discloses an injection molding machine that detects and monitors the locking force in the molding process using a tie bar sensor configured to detect a locking force. When the filling pressure of the injected resin becomes higher than the locking force at the completion of the locking operation by a predetermined amount or more, the injection molding machine determines the filling pressure as abnormal and then immediately stops the molding process.

Jpn. Pat. Appln. KOKAI Publication No. 2004-160682 discloses an injection molding method that detects the elongation amount of the tie bar in the injecting process based on the elongation amount of the tie bar when the locking operation has been finished. In the injection molding method, the detected value of the elongation amount of the tie bar is converted into the die opening amount and is shown as a waveform. Based on the die opening amount shown as the waveform, an appropriate locking force is set for injection-molding a product.

Jpn. Pat. Appln. KOKAI Publication No. 8-066951 discloses an injection molding machine that performs an injection molding where a predetermined maximum locking force P_{M} is set as the initial locking force. In the injection molding machine, a preset maximum distance between platens Lₘₐₓ, and an acceptable excess amount E have been set. The injection molding machine repeats injection-molding while decreasing the initial locking force by a predetermined amount ΔP until an excess amount e exceeds the acceptable excess amount E. The excess amount e denotes the amount when the maximum distance between the platens that has been detected in the injection molding process exceeds the preset maximum distance between platens Lₘₐₓ. The injection molding machine determines the initial locking force at the previous shot as the optimal value for locking operation when the excess amount e exceeds the acceptable excess amount E, and executes mass production molding.

Jpn. Pat. Appln. KOKAI Publication No. 8-252849 discloses an injection molding machine that detects the injection pressure in the injection filling process. The injection molding machine multiplies a detected pressure value Dp by a predetermined coefficient to convert the detected pressure value Dp into a reference value of the locking force Fc. The injection molding machine controls the locking force according to the reference value of the locking force Fc.

Jpn. Pat. Appln. KOKAI Publication No. 7-100893 discloses an injection molding machine that comprises a sensor and a controller. The sensor detects a gap amount L between a stable die and a movable die. The controller controls a driving source using a detected signal output by the sensor. The controller of the injection molding machine locks the dies with the minimum locking force F₁ to keep the dies closed, after the closing operation was completed. When the filling of resin starts, the controller controls the driving source to keep the gap amount at a constant value L₀ during the filling process.

The operator can freely set the maximum injection pressure of the molding machine in the injecting process basically. Setting the injection pressure too high causes a shortage of the locking force. In this case, the dies are separated and a malfunction such as forming a burr on the product may occur.

### BRIEF SUMMARY OF THE INVENTION

An object of the present invention is to provide a molding machine and an injection molding controlling method capable of reducing the malfunctions likely to occur in the injecting process.

To achieve the object, a molding machine according to an embodiment of the present invention comprises a stationary platen equipped with a stationary die, a movable platen equipped with a movable die, a locking drive mechanism configured to move the movable platen forward or backward and to lock the movable die against the stationary die, a detecting portion configured to detect information about a locking state, an injection device, and a control unit configured to monitor the information obtained by the detecting portion in an injecting process and to control an injection pressure of the injection device based on a value obtained from the information.

To achieve the object, an injection molding controlling method according to an embodiment of the present invention is applied to a molding machine which comprises a stationary platen equipped with a stationary die, a movable platen equipped with a movable die, a locking drive mechanism configured to move the movable platen forward or backward and to lock the movable die against the stationary die, a detecting portion configured to detect information about a locking state, and an injection device. The injection molding controlling method comprises monitoring information obtained by the detecting portion in an injecting process, and restraining an injection pressure of the injection device based on a value obtained from the information.

The present invention can reduce the malfunctions in the injecting process.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a side view of a molding machine according to a first embodiment;

FIG. 2 is an exemplary block diagram of the configuration of a controller shown in FIG. 1;

FIG. 3 is a flowchart of the injecting process by the molding machine shown in FIG. 1;

FIG. 4 is a graph of the relationship between the locking force and the injection pressure in the molding machine shown in FIG. 1;

FIG. 5 is a graph of the relationship between the locking force and the injection pressure in a molding machine according to a second embodiment;

FIG. 6 is a graph of the relationship between the locking force and the injection pressure in a molding machine according to a third embodiment;

FIG. 7 is a graph of the relationship between the locking force and the injection pressure in a molding machine according to an exemplary modification of the third embodiment;

FIG. 8 is a side view of a molding machine according to a fourth embodiment;

FIG. 9 is a graph of the relationship between the distance between the dies and the injection pressure in the molding machine shown in FIG. 8;

FIG. 10 is a graph of the relationship between the distance between the dies and the injection pressure in a molding machine according to a fifth embodiment;

FIG. 11 is a graph of the relationship between the distance between the dies and the injection pressure in a molding machine according to a sixth embodiment;

FIG. 12 is a graph of the relationship between the distance between the dies and the injection pressure in a molding machine according to an exemplary modification of the sixth embodiment; and

FIG. 13 is a graph of the relationship between the locking force and the injection pressure in a molding machine as an exemplary comparison to the first embodiment.

### DETAILED DESCRIPTION OF THE INVENTION

Hereinafter, some embodiments will be described with reference to the drawings.

### First Embodiment

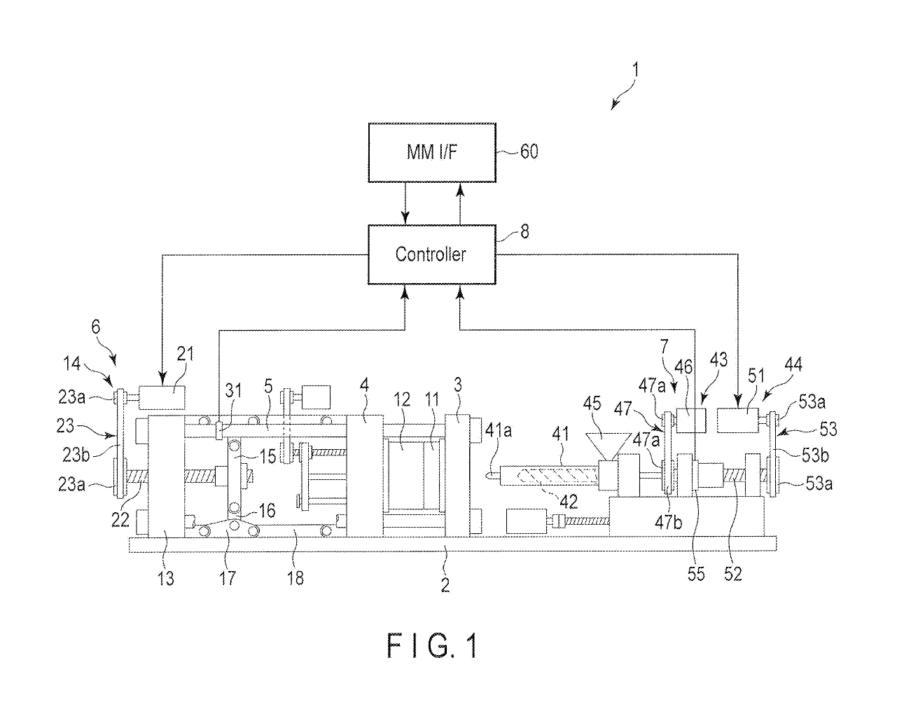

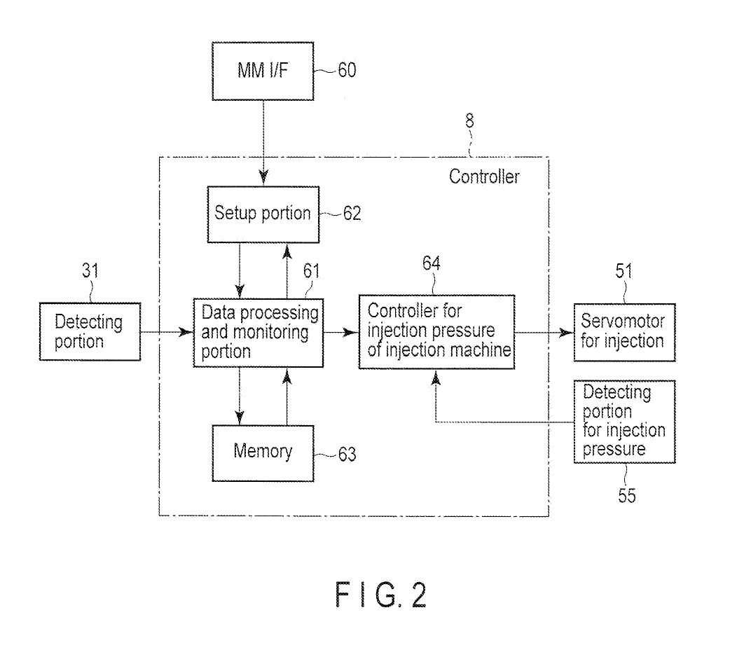

FIGS. 1, 2, 3, and 4 disclose an injection molding machine 1 according to a first embodiment of the present invention. The injection molding machine 1 is an example of “a molding machine”. As shown in FIG. 1, the injection molding machine 1 comprises a frame 2, a stationary platen 3, a movable platen 4, a tie bar 5, a locking drive mechanism 6, an injection device 7, and a controller 8. The term of “locking” or “lock” can arbitrarily read as “clamping” or “clamp”.

The frame 2 is the foundation of the injection molding machine 1. A linear guide (not shown) is provided on the frame 2. The stationary platen 3 is fixed on the frame 2. The stationary platen 3 is equipped with a stationary die 11. For example, four tie bars 5 are provided. One of the ends of the tie bar 5 that is a first end is connected to the stationary platen 3. The tie bar 5 extends from the stationary platen 3 to the locking drive mechanism 6 through the movable platen 4.

The movable platen 4 is mounted on the linear guide of the frame 2. While guided by the tie bar 5 or the linear guide, the movable platen 4 can proceed in a direction toward the stationary platen 3 and recede in a direction away from the stationary platen 3. The movable platen 4 is equipped with a movable die 12. The movable die 12 is opposite to the stationary die 11. When the movable die 12 is attached to the stationary die 11, a cavity that fits the form of the product is formed between the stationary die 11 and the movable die 12.

The locking drive mechanism 6 is provided on the opposite side of the stationary platen 3 with respect to the movable platen 4. A toggle mechanism is an example of the locking drive mechanism 6. Note that the configuration of the locking drive mechanism 6 is not limited to the toggle mechanism and can be, for example, a configuration using a hydraulic cylinder and a tie bar or other configurations. The locking drive mechanism 6 according to the present embodiment comprises, for example, a toggle support 13, a toggle mechanism diver 14, a crosshead 15, a first toggle lever 16, a second toggle lever 17, and a toggle arm 18.

The toggle support 13 is a supporter of the toggle-type locking device and is supported on the frame 2 as a baroreceptor. The other end of the tie bar 5 that is a second end is connected to the toggle support 13. The toggle mechanism diver 14 is provided at the toggle support 13 and comprises, for example, locking servomotor 21, a ball screw 22, and a transmission mechanism 23.

The crosshead 15 is attached to the tip of the ball screw 22. The ball screw 22 is an example of a motion direction changing mechanism configured to change a rotational motion into a linear motion. When the ball screw 22 is turned, the crosshead 15 proceeds toward or recedes from the movable platen 4 as moving in a right and left direction in FIG. 1.

The transmission mechanism 23 comprises, for example, a rotator 23a that is a pulley in the present embodiment, and a linear object 23b that is a timing belt in the present embodiment and is looped over the rotator 23a. The transmission mechanism 23 transmits the rotation of the locking servomotor 21 to the ball screw 22. Accordingly, when the locking servomotor 21 rotates, the crosshead 15 proceeds or recedes.

The first toggle lever 16 is connected to the crosshead 15. The second toggle lever 17 is placed between the toggle support 13 and the first toggle lever 16. The toggle arm 18 is placed between the second toggle lever 17 and the movable platen 4. The toggle support 13 and the second toggle lever 17, the first toggle lever 16 and the second toggle lever 17, the second toggle lever 17 and the toggle arm 18, the crosshead 15 and the first toggle lever 16, and the toggle arm 18 and the movable platen 4 are swingably linked to each other, respectively.

When the crosshead 15 proceeds or recedes, the toggle mechanism is activated. In other words, when the crosshead 15 proceeds, or moves in a right direction in FIG. 1, the movable platen 4 also moves toward the stationary platen 3 to close the dies. The locking force multiplied by a toggle power is added to the movable platen 4 so that the movable die 12 and the stationary die 11 are clamped. Note that the configurations of the toggle mechanism and the toggle mechanism driver are not limited to the above and can be other configurations.

As shown in FIG. 1, the injection molding machine 1 according to the present embodiment comprises a detecting portion 31 configured to detect information about the locking state. The locking state is referred to as the die-closed state. The detecting portion 31 according to the present embodiment detects, for example, the information about the locking force. The detecting portion 31 is provided, for example, at the tie bar 5 to detect the elongation amount of the tie bar 5. The elongation amount of the tie bar 5 is an example of the “information about the locking force”. The “information about the locking force” is sometimes referred to as the “information about the locking state”. Note that the “information about the locking force” (“information about the locking state”) is not limited to the value showing the directly measured locking force or the like, and can be the information that is referred to by the controller 8 to calculate the locking force or the locking state based on the information.

The detecting portion 31 transmits the detected “information about the locking force” to the controller 8. A detecting portion 31 or a plurality of detecting portions 31 can be provided. When the plurality of detecting portions 31 is provided, the detecting portions 31 can be provided at the four tie bars 5, respectively, or at the two tie bars 5, respectively. The two tie bars are diagonally positioned.

The detecting portion 31 is not limited to the above and can be, for example, a sensor configured to detect the rotation number or torque of the locking servomotor 21. The controller 8 can calculate the locking force according to the information such as the rotation number or torque of the locking servomotor 21.

The detecting portion 31 can also obtain the information about the locking state based on, for example, the position of one or a plurality of members included in the locking drive mechanism 6. A sensor configured to detect, for example, the position of the crosshead 15 is an example of the detecting portion 31. In such a case, the sensor is not limited to a position sensor configured to directly detect the position of the crosshead 15. The sensor can also be configured to measure, for example, the rotation number or torque of the locking servomotor 21 using the controller 8 to detect the position of the crosshead 15 based, on the measured result. The information about the locking force can be obtained by detecting the position of the crosshead 15. Note that the detecting portion 31 can be a sensor other than a position sensor.

Next, the injection device 7 will be described.

The injection device 7 is provided at the rear of the stationary platen 3. The injection device 7 comprises a heating barrel 41, a screw 42, a measure 43, and an injection device driver 44. The measure 43 may be referred to as a metering 43. The heating barrel 41 comprises a nozzle 41a configured to inject a molten material into a mold, and is connected to a hopper 45. The screw 42 is configured to move inside the heating barrel 41 in a right and left direction in FIG. 1, or proceed or recede.

The measure 43 comprises a servomotor for measurement 46, and a transmission mechanism 47 configured to transmit the rotation of the servomotor for measurement 46 to the screw 42. The transmission mechanism 47 comprises, for example, a rotator 47a that is a pulley in the present embodiment, and a linear object 47b that is a timing belt in the present embodiment and is looped over the rotator 47a. When the servomotor for measurement 46 is activated and the screw 42 rotates inside the heating barrel 41, resin used as a raw material is injected from the hopper 45 into the heating barrel 41. While heated and kneaded, the injected resin is transmitted to the tip of the heating barrel 41 and then becomes a molten resin and is stocked at the tip of the heating barrel 41. In such a case, the raw material is not limited to resin. Anything, for example, a metal, a glass, a rubber, a carbonized compound including carbon fiber, and the like can be the raw material, if it can be used as a material for molding. The raw material is just referred to as the material.

The injection device driver 44 comprises a servomotor for injection 51, a ball screw 52, and a transmission mechanism 53. The ball screw 52 is an example of a motion direction changing mechanism configured to change a rotational motion into a linear motion, and is connected to the screw 42. When the ball screw 52 is rotated, the screw 42 proceeds or recedes inside the heating barrel 41 as moving in a right and left direction in FIG. 1.

The transmission mechanism 53 comprises, for example, a rotator 53a that is a pulley in the present embodiment, and a linear object 53b that is a timing belt in the present embodiment and is looped over the rotator 53a. The transmission mechanism 53 transmits the rotation of the servomotor for injection 51 to the ball screw 52. Accordingly, when the servomotor for injection 51 rotates, the screw 92 proceeds or recedes. Note that the configuration of the injection device driver 44 is not limited to the above and can be other configurations.

The injection device 7 comprises a detecting portion for injection pressure 55 configured to detect the information about the injection pressure of the injection device 7. Note that the position of the detecting portion for injection pressure 55 is not limited to that shown in FIG. 1. The detecting portion for injection pressure 55 can be placed at another position in the injection device 7. The detecting portion for injection pressure 55 transmits the information about the detected injection pressure to the controller 8. Note that the “information about the injection pressure” is not limited to the value showing the directly measured injection pressure, and can be the information that is referred to by the controller 8 to calculate the injection pressure based on the measured information. Note that the directly measured injection pressure of the injection device 7 is obtained by adopting, for example, a pressure sensor as the detecting portion for injection pressure 55. The controller 8 calculates the injection pressure of the injection device 7 based on the information about the injection pressure. The injection pressure of the injection device 7 is controlled by controlling, for example, the drive of the servomotor for injection 51 or, in other words, by controlling the proceeding speed that is the injection speed of the screw 42.

As shown in FIG. 1, the injection molding machine 1 comprises a man machine interface (MMI/F) 60. The MMI/F 60 is also referred to as a human machine interface (HMI). The operator can input, through the MMI/F 60, the setting such as instructions about the motion of the injection molding machine 1. The information that can be input through the MMI/F 60 includes, for example, a set value P1, a set value showing the locking force, and a set condition. The set value P1 shows the maximum injection pressure in the injecting process at the injection device 7. The set condition is used for determining whether the normal mode is switched to the injection pressure restraint mode described below.

The controller 8 is an example of a “control unit”. The controller 8 monitors the information received from the detecting portion 31 in the injecting process. When a value obtained from the received information, namely, a value included in the information, or a value calculated based on the value included in the information exceeds a predetermined threshold, the controller 8 restrains the injection pressure of the injection device 7. In other words, the controller 8 monitors the information obtained by the detecting portion 31 in the injecting process, and restrains the injection pressure of the injection device 7 based on the value obtained from the information.

In the present embodiment, the controller 8 stores the value related to the locking state at the beginning of the injecting process and uses the value as the threshold. The value has been obtained from the information in the detecting portion 31. In the present embodiment, the controller 8 uses the locking force at the beginning of the injecting process as the threshold. In other words, when the value showing the locking force in the injecting process that has been obtained from the information in the detecting portion 31 exceeds the value showing the locking force at the beginning of the injecting process that has been set as the threshold, the controller 8 controls the injection pressure.

The details are as follows. An example of the controller 8 comprises a data processing portion 61, a setup portion 62, a memory 63, and a controller for injection pressure of injection machine 64. Note that the functions can be independently provided and can be also provided while some of the functions are combined.

The setup portion 62 stores the information input through the MMI/F 60. The setup portion 62 stores, for example, the information about the set value P1, the set value showing the locking force, the setting of the condition where the normal mode is switched to the injection pressure restraint mode, and the like. The set value P1 shows the maximum injection pressure input by the operator as a first set value or an initial set value. The memory 63 stores the information about the locking state at the beginning of the injecting process or at the completion of the locking process. The information has been obtained from the information in the detecting portion 31. In the present embodiment, the memory 63 stores the value showing the locking force at the beginning of the injecting process.

The controller for injection pressure of injection machine 64 controls the drive of the servomotor for injection 51. The controller for injection pressure of injection machine 64 controls the injection pressure of the injection device 7, for example, by controlling the drive of the servomotor for injection 51. The controller for injection pressure of injection machine 64 receives the actual measured value of the injection pressure from the detecting portion for injection pressure 55. While referring to the actual measured value obtained by the detecting portion for injection pressure 55, the controller for injection pressure of injection machine 64 keeps the injection pressure at a given value. In the normal mode, the controller for injection pressure of injection machine 64 restrains the injection pressure from exceeding the set value P1 showing the maximum injection pressure based on the set value P1 showing the maximum injection pressure input by the operator.

The data processing portion 61 exchanges the information with the setup portion 62 to refer to, for example, the set value P1 showing the maximum injection pressure input by the operator, the set value showing the locking force, the set condition for switching the normal mode to the injection pressure restraint mode, and the like.

Further, the data processing portion 61 is an example of a monitor, and monitors the information about the locking state transmitted from the detecting portion 31, for example, the information about the locking force. The data processing portion 61 compares the value showing the locking force in the injecting process that has been obtained from the information in the detecting portion 31 to the “value showing the locking force at the beginning of the injecting process” stored in the memory 63 in order to determine which value is large. When the value showing the locking force in the injecting process exceeds the value showing the locking force at the beginning of the injecting process, the data processing portion 61 determines that the set value P1 showing the maximum injection pressure set by the operator is too high, and switches the normal mode to the injection pressure restraint mode.

In an example of the injection pressure restraint mode, the controller 8 automatically updates the set value showing the injection pressure of the injection device 7, for example, the set value showing the maximum injection pressure with a new set value lower than the previous set value. The controller 8 controls the injection pressure to restrain the value obtained from the information in the detecting portion 31 from exceeding the threshold based on the new set value.

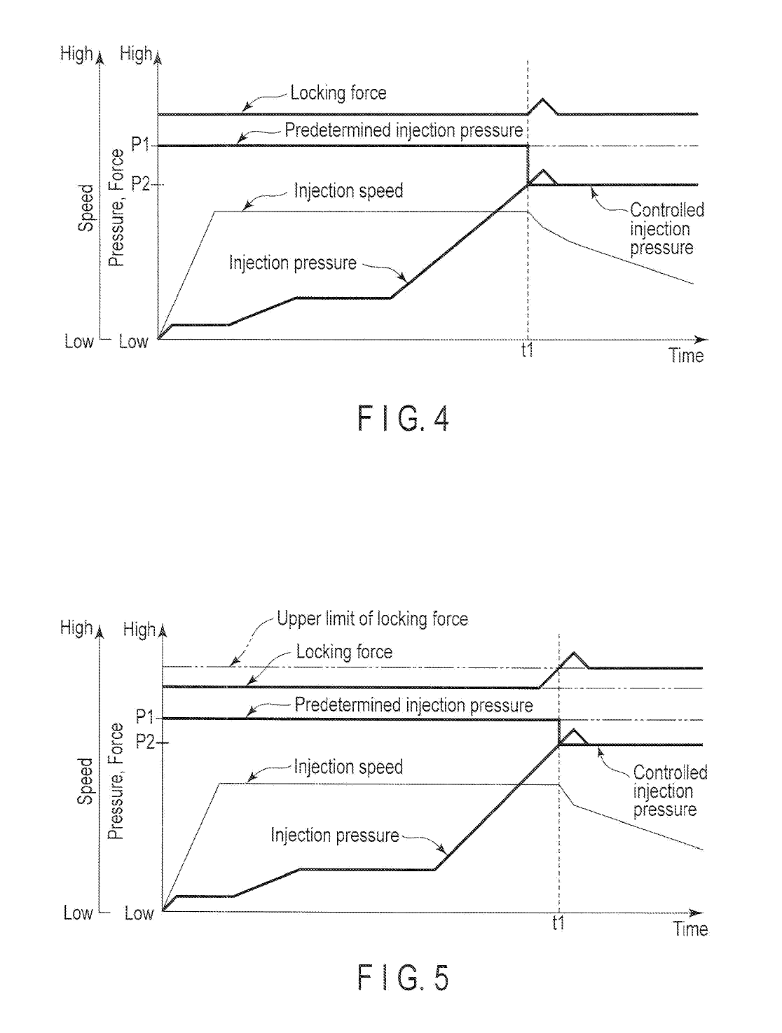

In the present embodiment, the controller 8 sets the value showing the injection pressure at the time of t1 shown in FIG. 4 as the maximum value of the injection pressure after the time. At the time of t1, the value showing the locking force in the injecting process exceeds the value showing the locking force at the beginning of the injecting process stored in the memory 63, namely, the threshold, and starts to increase. Then, the injection pressure after the time is restrained from exceeding the maximum value. In other words, the controller 8 updates the value showing the injection pressure at t1 shown in FIG. 4 with a set value P2 from the initial set value P1 in order to control the injection pressure after the t1 based on the new set value P2. The set value P2 is a second set value and shows a new maximum value of the injection pressure.

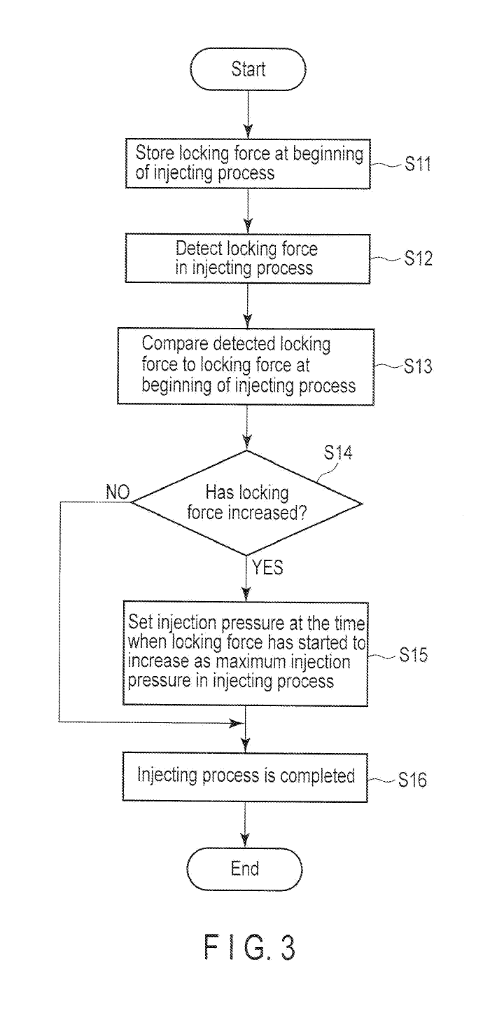

Next, the action of the controller 8 according to the present embodiment will be described with reference to FIGS. 3 and 4. Note that the crests in the waveforms of the injection pressure and the locking force after the time of t1 shown in FIG. 4 are exaggerated for purposes of illustration.

As shown in FIG. 3, the information about the locking force at the beginning of the injecting process is detected by the detecting portion 31. The information is transmitted to the controller 8, processed as necessary, and is stored in the memory 63 as a threshold (S11). For example, the strength of the locking force in the injecting process according to the present embodiment is kept constant from the beginning of the injecting process as shown in FIG. 4. In other words, unless the set value P1 showing the maximum injection pressure input by the operator is too high, the locking force in the injecting process according to the present embodiment is kept at the value at the beginning of the injecting process. In the normal mode, the controller 8 restrains the injection pressure from exceeding the set value P1 showing the maximum injection pressure set by the operator.

As shown in FIG. 3, the detecting portion 31 detects the information about the locking force in the injecting process, and transmits the information to the controller 8 (S12). The controller 8 compares the value showing the locking force in the injecting process obtained from the information in the detecting portion 31 to the value showing the locking force at the beginning of the injecting process stored in the memory 63 (S13). When the locking force in the injecting process is kept lower than the value showing the locking force at the beginning of the injecting process that is the threshold until the end of the injecting process, the injecting process is completed in the normal mode.

When the set value P1 showing the maximum injection pressure set by the operator is too high, the force acts in a direction where the dies is forced separately as the injection pressure increases shown in FIG. 4. This increases the locking force in the injecting process. As shown in FIG. 3, the controller 8 compares the value showing the locking force in the injecting process to the value showing the locking force at the beginning of the injecting process (S13). When the value showing the locking force in the injecting process is larger than the value showing the locking force at the beginning of the injecting process, the controller 8 detects that the locking force increased (S14).

When detecting that the locking force increased, the controller 8 switches the motion of the injection molding machine 1 from the normal mode to the injection pressure restraint mode. Specifically, the injection pressure at the time of t1 shown in FIG. 4 is reset as the set value P2 showing the new maximum injection pressure in the injecting process as shown in FIGS. 3 and 4 (S15). At the time of t1, the locking force in the injecting process exceeds the threshold and starts to increase. In other words, in the injecting process after the time, the controller 8 restrains the injection pressure from exceeding the set value P2 showing the new maximum injection pressure.

In other words, after the locking force starts to increase, the injection pressure is restrained as shown in FIG. 4. The injection pressure is decreased to the set value P2 showing the new maximum injection pressure that has been reset lower and is kept at, for example, the set value P2 showing the new maximum injection pressure. As a result, the locking force in the injecting process is decreased to the value at the beginning of the injecting process that is the threshold, and is kept at the value at the beginning of the injecting process. Then, the injecting process is completed as shown in FIG. 3 (S16).

The injection molding machine 1 configured as above can reduce the malfunctions in the injecting process, such as a burr of the product, damage to the dies, or the like.

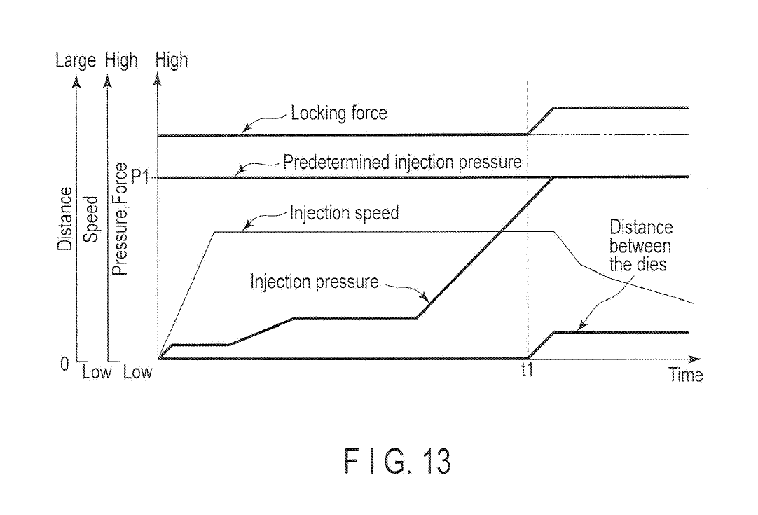

For the purpose of comparison, an injection molding machine according to the present embodiment that does not have the controller 8 will be described with reference to FIG. 13. As shown in FIG. 13, when the operator has set the set value P1 showing the maximum injection pressure too high, the locking force in the injecting process increases as the injection pressure increases. The injection pressure increases until reaching the set value P1 showing the maximum injection pressure set by the operator. The locking force also increases until then.

When the operator has set the set value showing the injection pressure too high, the locking force fewer than the injection pressure separates the dies. This can cause a malfunction such as a burr of the product, damage to the dies, or the like. In a toggle-type locking device, the locking device can be damaged when the locking force increases.

The injection molding machine 1 according to the present embodiment comprises the controller 8 configured to monitor the information obtained by the detecting portion 31 in the injecting process. When the value obtained based on the information exceeds a predetermined threshold, the controller 8 restrains the injection pressure of the injection device 7. Accordingly, the injection pressure is restrained before the locking force largely increases in the injecting process. This reduces the occurrence of burrs of the product. Thus, this reduces mold defects and causes the efficient production. Further, the locking force is restrained from increasing in the injecting process so that the damage to the dies or the locking device can be reduced.

In the present embodiment, the controller 8 sets the value of the injection pressure at the time when the value detected by the detecting portion 31 exceeds the threshold and starts to increase as the maximum value of the injection pressure, and restrains the injection pressure after the time from exceeding the maximum value. Accordingly, the injection pressure is kept relatively high while the locking force does not become too large. This reduces malfunctions such as an insufficient filling due to the decreased injection pressure.

Next, the injection molding machine 1 and an injection molding controlling method according to an exemplary modification of the first embodiment will be described. In a general injecting process, the value showing the locking force sometimes varies to a degree due to, for example, an error from the properties of the detecting portion 31, the calculation in the controller 8, or the like. For example, although a locking is performed with the locking force set as 50 MPa, the locking force sometimes varies to a degree and becomes, for example, 49.9 MPa or 49.8 MPa.

Considering the above-mentioned error, in the present exemplary modification, the controller 8 sets a predetermined sampling period for obtaining data at the monitored part in the injecting process, and monitors the value related to the locking state such as a locking force at each of the sampling periods. In other words, the controller 8 continuously monitors the value related to the locking state at predetermined time intervals. The controller 8 uses, as the threshold in a sampling period, the value related to the locking state that has been detected at the immediately preceding sampling period. For example, when the locking force in the injecting process exceeds the locking force obtained at the immediately preceding sampling period, the controller 8 switches the control mode to the injection pressure restraint mode. Note that “in a sampling period” means “during one sampling period”, and is chosen freely at the moment from sampling periods which are continuously carried out and have a predetermined length respectively.

For example, although the locking force at the beginning of the injecting process is 50 MPa, the controller 8 according to the exemplary modification constantly monitors the locking force during the injecting process regardless of the locking force of 50 MPa at the beginning of the injecting process. When the locking force at one moment in the injecting process exceeds the locking force obtained at the immediately preceding sampling period, the controller 8 sets the injection pressure of that moment as the maximum injection pressure in the injecting process after the moment, and controls the injection pressure. The above-mentioned configuration also reduces the malfunctions in the injecting process in the same manner as the first embodiment.

### Second Embodiment

Next, the injection molding machine 1 and an injection molding controlling method according to a second embodiment of the present invention will be described with reference to FIG. 5. The configurations having the same or similar functions as those in the injection molding machine 1 according to the first embodiment are denoted with the same reference numbers in FIG. 5. The corresponding description of the first embodiment should be referred to as the description of the present embodiment. The configurations other than described below are same as those of the first embodiment.

In the present embodiment, the controller 8 uses, as the threshold, the value obtained by adding a predetermined value or a value input by the user settings to the value related to the locking state at the beginning of the injecting process that has been obtained base on the information in the detecting portion 31.

An example of the controller 8 uses, as the threshold that is the upper limit of the locking force, the value obtained by adding, for example, the value that has been set in advance as the internal parameter of the injection molding machine 1, or the value input by the operator through the MMI/F 60 to the value showing the locking force at the beginning of the injecting process. When the value showing the locking force in the injecting process exceeds the threshold that is the upper limit of the locking force, the controller 8 determines that the set value P1 showing the maximum injection pressure set by the operator is too high, and switches the control mode from the normal mode to the injection pressure restraint mode.

Note that, in place of the above-mentioned configuration, the controller 8 can monitor the value related to the locking state at each predetermined sampling period in the injecting process, for example, the locking force; and can use, as the above-mentioned threshold, the value obtained by adding the preset value or the value input by the user settings to the value related to the locking state that has been detected at the immediately preceding sampling period, for example, the locking force.

Note that, in place of the above-mentioned two configurations, the controller 8 can set the value preset in the internal parameter or the value input by the operator as the absolute value of the upper limit of the locking force, namely, the absolute value of the threshold. In other words, when the locking force in the injecting process exceeds the value preset in the internal parameter or the value input by the operator, the controller 8 switches the control mode from the normal mode to the injection pressure restraint mode.

These configurations can also reduce the malfunctions in the injecting process in the same manner as the first embodiment. Further, they can arbitrarily set the upper limit of the locking force as the threshold. This increases the degree of flexibility in the control of the injecting process.

### Third Embodiment

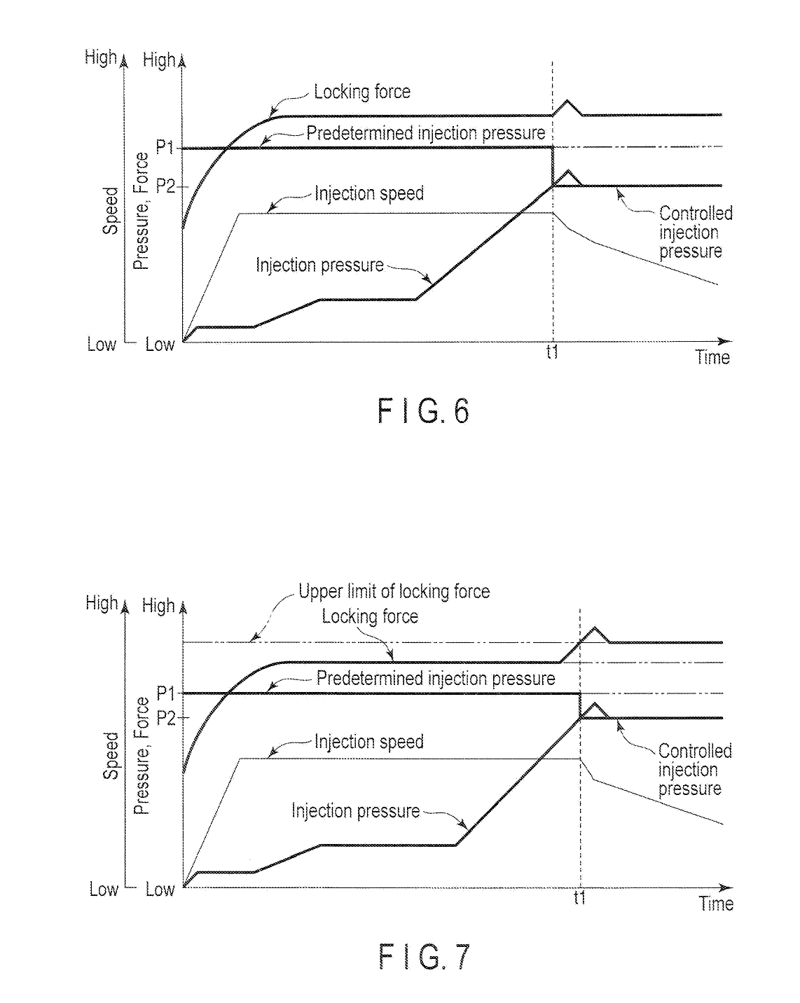

Next, the injection molding machine 1 and an injection molding controlling method according to a third embodiment of the present invention will be described with reference to FIG. 6. The configurations having the same or similar functions as those in the injection molding machine 1 according to the first embodiment are denoted with the same reference numbers in FIG. 6. The corresponding description of the first embodiment should be referred to as the description of the present embodiment. The configurations other than described below are same as those of the first embodiment.

As shown in FIG. 6, in the present embodiment, the locking force in the injecting process is not constant from the beginning of the injecting process, but increases from the beginning of the injecting process. In the present embodiment, various values can be used as the threshold in place of the locking force at the beginning of the injecting process. For example, the value showing the locking force at the time after a predetermined time has passed from the beginning of the injecting process can be used as the threshold.

FIG. 7 is a view of an exemplary modification of the present embodiment. In the exemplary modification shown in FIG. 7, the threshold can be set based on the preset value or the value input by the user settings in the same manner as the second embodiment.

These configurations can also reduce the malfunctions in the injecting process in the same manner as the first embodiment.

### Fourth Embodiment

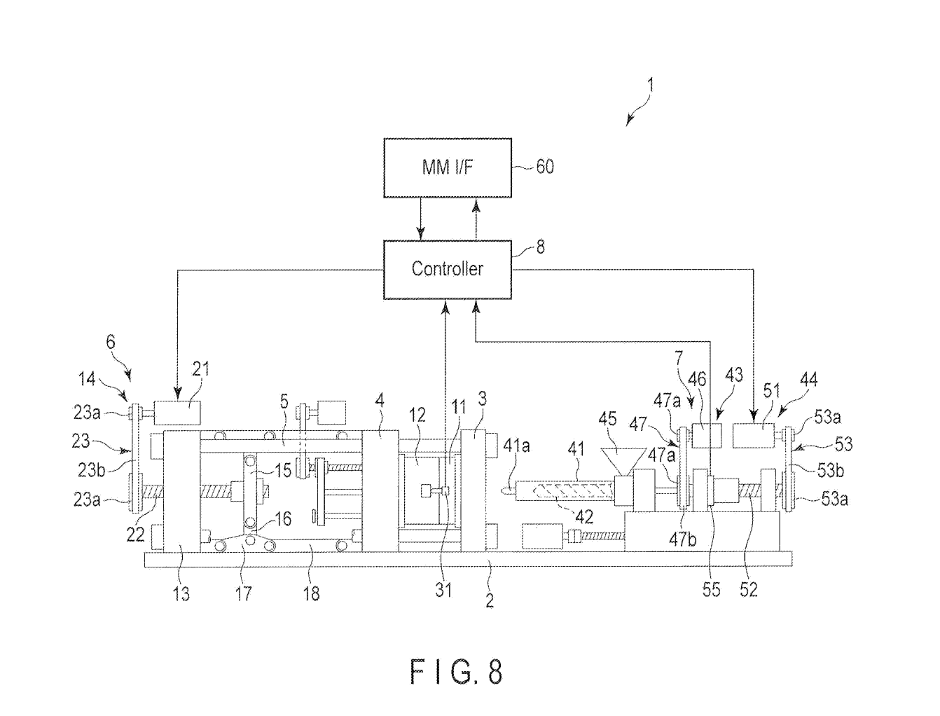

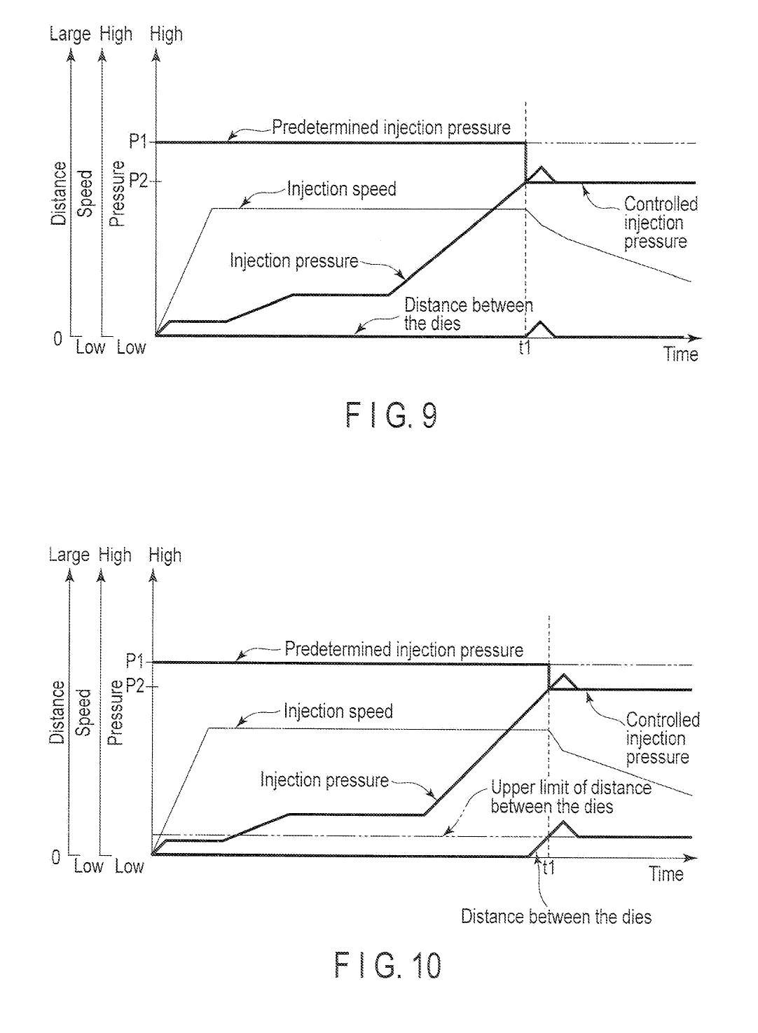

Next, the injection molding machine 1 and an injection molding controlling method according to a fourth embodiment of the present invention will be described with reference to FIGS. 8 and 9. The configurations having the same or similar functions as those in the injection molding machine 1 according to the first embodiment are denoted with the same reference numbers in FIGS. 8 and 9. The corresponding description of the first embodiment should be referred to as the description of the present embodiment. The configurations other than described below are same as those of the first embodiment.

As shown in FIG. 8, the injection molding machine 1 according to the present embodiment comprises, as the detecting portion 31 configured to detect the information about the locking state or the die-closing state, a die opening amount sensor configured to detect the information about the distance between the dies. An example of the detecting portion 31 is a distance sensor mounted on at least one of the stationary die 11 or the movable die 12, and detects the information about the distance between the stationary die 11 and the movable die 12. The information about the distance between the dies is not limited to the value showing the directly measured distance between the dies, and can also be the information referred to by the controller 8 to calculate the distance between the dies based on the information. One or a plurality of detecting portions 31 can be provided.

Note that the detecting portion 31 is not limited to the above-mentioned example and can also be a distance sensor mounted on at least one of the movable platen 4 or the stationary platen 3, or a vision sensor mounted on the locking device, for example, a camera or a video camera. Various types such as an optical type, a magnetic type, a magnetostrictive type, an ultrasonic type, a resistor, a potentiometer, or a differential transformer can be adopted as the drive principle of the distance sensor. Each type of the distance sensors includes a rotary type or a linear type, or a type having both of them. Any of them can be arbitrarily adopted. Although the linear type distance sensor is preferable as a distance sensor, the rotary type distance sensor can be used after the rotational motion is converted into a linear motion using a rack and a pinion. The vision sensor can be mounted on, for example, a stand, and be separated from the locking device. In the injection molding machine 1, the detecting portion 31 can detect the information about the locking force including the elongation amount of the tie bar 5, the position of the crosshead 15, and the like; and the controller 8 can calculate the information about the distance between the dies based on the detected information.

As shown in FIG. 9, in the present embodiment, the controller 8 uses the value showing the distance between the dies at the beginning of the injecting process as the threshold. When the value showing the distance between the dies in the injecting process that has been obtained from the information in the detecting portion 31 exceeds the value showing the distance between the dies at the beginning of the injecting process that has been set as the threshold, the controller 8 controls the injection pressure.

The details are as follows. The memory 63 stores the value showing the distance between the dies at the beginning of the injecting process. The data processing portion 61 monitors the information about the distance between the dies, which is output by the detecting portion 31. The data processing portion 61 compares the value showing the distance between the dies in the injecting process obtained based on the information in the detecting portion 31 to “the value showing the distance between the dies at the beginning of the injecting process” that is stored in the memory 63 to determine which is large. When the value showing the distance between the dies in the injecting process exceeds the value showing the distance between the dies at the beginning of the injecting process, the data processing portion 61 determines that the set value P1 showing the maximum injection pressure set by the operator is too high, and switches the control mode from the normal mode to the injection pressure restraint mode. For the other details, the description of the first embodiment can be applied while, for example, the term “the locking force” is read as “the distance between the dies”.

Note that, in the same manner as the exemplary modification of the first embodiment, the controller 8 can set a predetermined sampling period at the monitored part in the injecting process in order to monitor the distance between the dies at each of the sampling periods. In other words, the controller 8 continuously monitors the distance between the dies at predetermined time intervals. The controller 8 uses, as the threshold in a sampling period, the value showing the distance between the dies that has been detected at the immediately preceding sampling period. In other words, for example, when the value showing the distance between the dies in the injecting process exceeds the value showing the distance between the dies obtained at the immediately preceding sampling period, the controller 8 switches the control mode from the normal mode to the injection pressure restraint mode.

### Fifth Embodiment

Next, the injection molding machine 1 and an injection molding controlling method according to a fifth embodiment of the present invention will be described with reference to FIG. 10. The configurations having the same or similar functions as those in the injection molding machine 1 according to the first embodiment are denoted with the same reference numbers in FIG. 10. The description corresponding to the first embodiment is omitted from the description of the present embodiment. The configurations other than described below are same as those of the fourth embodiment.

In the present embodiment, in the same manner as the second embodiment, the threshold is set according to, for example, the value preset as the internal parameter or the value input by the user.

An example of the controller 8 uses, as the threshold that is the upper limit of the distance between the dies, the value obtained, for example, by adding the value preset as the internal parameter of the injection molding machine 1 or the value input by the operator through the MMI/F 60 to the value showing the distance between the dies at the beginning of the injecting process. When the value showing the distance between the dies in the injecting process exceeds the threshold that is the upper limit of the distance between the dies, the controller 8 determines that the set value P1 showing the maximum injection pressure set by the operator is too high, and switches the control mode from the normal mode to the injection pressure restraint mode.

Note that, in place of the above-mentioned configuration, the controller 8 can monitor the value showing the distance between the dies at each predetermined sampling period in the injecting process, and can use, as the above-mentioned threshold, the value obtained by adding the preset value or the value input by the user to the value showing the distance between the dies that has been detected at the immediately preceding sampling period.

Further, in place of the above-mentioned two configurations, the controller 8 can set the value preset in the internal parameter or the value input by the operator as the absolute value of the upper limit of the distance between the dies that is the absolute value of the threshold. In other words, when the distance between the dies in the injecting process exceeds the value preset in the internal parameter or the value input by the operator, the controller 8 can switch the control mode from the normal mode to the injection pressure restraint mode.

These configurations can also reduce the malfunctions in the injecting process in the same manner as the fourth embodiment. Further, they can arbitrarily set the upper limit of the distance between the dies as the threshold. This increases the degree of flexibility in the control of the injecting process.

### Sixth Embodiment

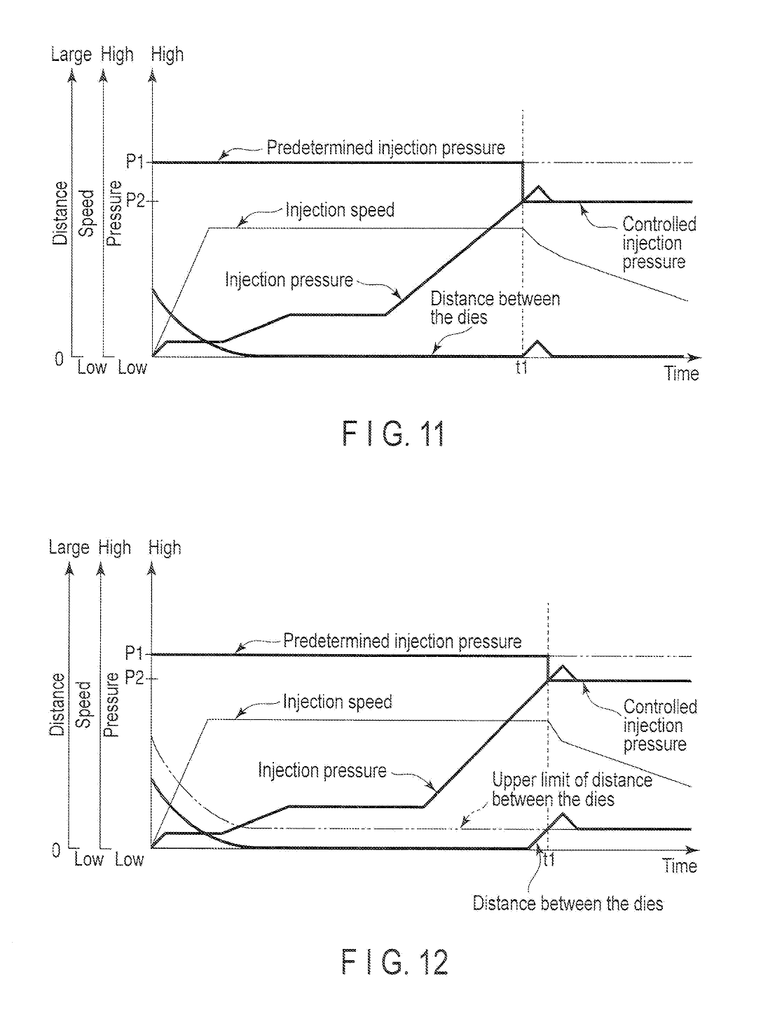

Next, the injection molding machine 1 and an injection molding controlling method according to a sixth embodiment of the present invention will be described with reference to FIG. 11. The configurations having the same or similar functions as those in the injection molding machine 1 according to the first embodiment are denoted with the same reference numbers in FIG. 11. The description corresponding to the first embodiment is omitted from the description of the present embodiment. The configurations other than described below are same as those of the fourth embodiment.

The sixth embodiment is similar to the third embodiment. The distance between the dies in the injecting process is not constant, but decreases from the beginning of the injecting process. In the present embodiment, various values can be used as the threshold in place of the distance between the dies at the beginning of the injecting process. For example, the value showing the distance between the dies after a predetermined time has passed from the beginning of the injecting process can be used as the threshold.

FIG. 12 is a view of an exemplary modification of the sixth embodiment. The exemplary modification shown in FIG. 12 is obtained by applying the exemplary modification of the third embodiment to the sixth embodiment. The threshold can be set based on, for example, the distance between the dies in the injecting process of the present embodiment and the preset value or the value input by the user settings.

These configurations can also reduce the malfunctions in the injecting process in the same manner as the first embodiment.

The first to sixth embodiments, and some exemplary modifications thereof have been described above. Each embodiment of the present invention is not limited to these. The elements according to each embodiment can be implemented by appropriately combining them. Furthermore, the present invention can be modified and embodied within the scope of the attached claims in the implementation phase thereof.

In the first to sixth embodiments, the controller 8 assumes, as a new set value P2 showing the injection pressure, the injection pressure at the time when the value obtained from the information in the detecting portion 31 exceeds the threshold. However, the embodiments are not limited to this. In the controller 8, a given value for decreasing the injection pressure can be set, for example, at the internal parameter set in advance or at the user settings. In other words, the set value P1 showing the maximum injection pressure is decreased by a given set amount and can be set as a new set value P2.

The threshold as a condition for switching from the normal mode to the injection pressure restraint mode is not limited to the value showing the locking force or the value showing the distance between the dies, and can be, for example, a value related to the other element different from the locking force and the distance between the dies. Further, the threshold is not limited to the value at the beginning of the injecting process, or the value input from the internal parameter or by the user settings, and can be another value. The present invention can be applied to not only an injection molding machine, but also another molding machine such as a die-cast machine, a transfer molding machine, and so on. The molding machines can obtain the same effects as the injection molding machine according to the present invention can do.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A molding machine comprising:
a stationary platen equipped with a stationary die;
a movable platen equipped with a movable die;
a locking drive mechanism configured to move the movable platen forward or backward and to lock the movable die against the stationary die;
a detecting portion configured to detect information about a locking state;
an injection device; and
a control unit configured to monitor the information obtained by the detecting portion in an injecting process and to control an injection pressure of the injection device based on a value obtained from the information.

2. The molding machine of claim 1, wherein
the control unit restrains the injection pressure of the injection device when the value obtained by the information exceeds a preset threshold.

3. The molding machine of claim 1, wherein
the control unit controls the injection pressure to keep the value at the threshold or lower when the value exceeds the threshold.

4. The molding machine of claim 1, wherein
the control unit sets a value showing the injection pressure at the time when the value exceeds the threshold and starts to increase as a maximum value of the injection pressure in the injecting process in order to restrain an injection pressure after the time from exceeding the maximum value.

5. An injection molding controlling method for a molding machine which comprises:
a stationary platen equipped with a stationary die;
a movable platen equipped with a movable die;
a locking drive mechanism configured to move the movable platen forward or backward and to lock the movable die against the stationary die;
a detecting portion configured to detect information about a locking state; and
an injection device;
the injection molding controlling method comprising:
monitoring information obtained by the detecting portion in an injecting process; and
restraining an injection pressure of the injection device based on a value obtained from the information.

6. The injection molding controlling method of claim 5, further comprising:
restraining the injection pressure of the injection device when the value obtained from the information exceeds a preset threshold.

7. The injection molding controlling method of claim 5, further comprising:
controlling the injection pressure to keep the value at the threshold or lower when the value exceeds the threshold.

8. The injection molding controlling method of claim 5, further comprising:
setting a value showing the injection pressure at the time when the value exceeds the threshold and starts to increase as a maximum value of the injection pressure in the injecting process; and
restraining an injection pressure after the time from exceeding the maximum value.
